(19) United States
(12) Patent Application Publication
(10) Pub. No.: US 2024/0364127 A1
(43) Pub. Date: Oct. 31, 2024

(54) ELECTRONIC DEVICE AND POWER MANAGEMENT METHOD THEREOF

(71) Applicants: Chih-Fan Weng, Taipei City (TW); Wei-Chih Shih, Taipei City (TW); Yi-Hsun Lin, Taipei City (TW); Ping-Wen Kuo, Taipei City (TW); Chang-Hsiang Tsao, Taipei City (TW); Jia-Ming Lin, Taipei City (TW); Min-Hsiu Hsieh, Taipei City (TW)

(72) Inventors: Chih-Fan Weng, Taipei City (TW); Wei-Chih Shih, Taipei City (TW); Yi-Hsun Lin, Taipei City (TW); Ping-Wen Kuo, Taipei City (TW); Chang-Hsiang Tsao, Taipei City (TW); Jia-Ming Lin, Taipei City (TW); Min-Hsiu Hsieh, Taipei City (TW)

(73) Assignee: COMPAL ELECTRONICS, INC., Taipei City (TW)

(21) Appl. No.: 18/509,242

(22) Filed: Nov. 14, 2023

Related U.S. Application Data
(60) Provisional application No. 63/462,534, filed on Apr. 28, 2023.

(51) Int. Cl. H02J 7/00; H01M 10/42; H01M 10/48

(52) U.S. Cl. CPC H02J 7/00712; H01M 10/425; H01M 10/48; H01M 10/486; H02J 7/00309; H02J 7/0047; H02J 7/0063; H01M 2010/4271

(57) ABSTRACT

An electronic device and a power management method thereof are provided. The power management method includes: detecting a plurality of status information of a plurality of operation statuses of a battery set; determining an information value range within which each of the status information of each of the operation statuses falls, calculating a weighting value of each of the operation statuses according to the information value range; and calculating a weighting value sum corresponding to the weighting values of the operation statuses to set a load capacity of the battery set according to the weighting value sum.

### CROSS-REFERENCE TO RELATED APPLICATION

This application claims the priority benefit of U.S. provisional application Ser. No. 63/462,534, filed on Apr. 28, 2023. The entirety of the above-mentioned patent application is hereby incorporated by reference herein and made a part of this specification.

### BACKGROUND

### Technical Field

The disclosure relates to an electronic device and a power management method thereof, and in particular, to an electronic device that may dynamically adjust a load capacity in real time and a power management method thereof.

### Description of Related Art

In the conventional technical field, regarding the power management method of the battery set, the system may detect the specific operation status of the battery set. When the system detects that the relevant information of the battery set reaches a set value, the system may reduce the performance of the battery set so as to prevent the battery set from entering a protection status which is caused by the overuse of the battery set. However, the set value is an individual single fixed value and does not take into account variables such as aging or low capacity of the battery set, and unsuitable setting of the set value which may trigger the protection status of the battery set and cause the system to shut down abnormally.

### SUMMARY

The disclosure provides an electronic device and a power management method thereof, which may dynamically adjust the maximum load capacity of the electronic device in real time.

A power management method of the disclosure includes the following steps. A plurality of status information of a plurality of operation statuses of a battery set is detected. An information value range within which each of the status information of each of the operation statuses falls is determined. A weighting value of each of the operation statuses is calculated according to the information value range. A weighting value sum corresponding to the weighting values of the operation statuses is calculated to set a load capacity of the battery set according to the weighting value sum.

An electronic device of the disclosure includes a battery set, an operation status detection device, and a controller. The operation status detection device is coupled to the battery set and configured to detect a plurality of status information of a plurality of operation statuses of the battery set. The controller is coupled to the operation status detection device. The controller is configured to determine an information value range within which each of the status information of each of the operation statuses falls, calculate a weighting value of each of the operation statuses according to the information value range, and calculate a weighting value sum corresponding to the weighting values of the operation statuses to set a load capacity of the battery set according to the weighting value sum.

According to the above, the electronic device of the disclosure detects the plurality of status information of the plurality of operation statuses of the battery set, determines the information value range within which each of the status information falls to set the weighting value corresponding to the status information, and calculates the weighting value sum to set the load capacity of the battery set according to the weighting value sum.

### BRIEF DESCRIPTION OF THE DRAWINGS

FIG. 1 is a flow chart of a power management method according to an embodiment of the disclosure.

FIG. 2 is a flow chart of a power management method according to another embodiment of the disclosure.

FIG. 3 is a flow chart of a power management method according to another embodiment of the disclosure.

FIG. 4 and FIG. 5 are schematic diagrams of a setting method of a reference range in a power management method according to the embodiment of the disclosure.

FIG. 6 is a schematic diagram of an electronic device according to an embodiment of the disclosure.

### DESCRIPTION OF THE EMBODIMENTS

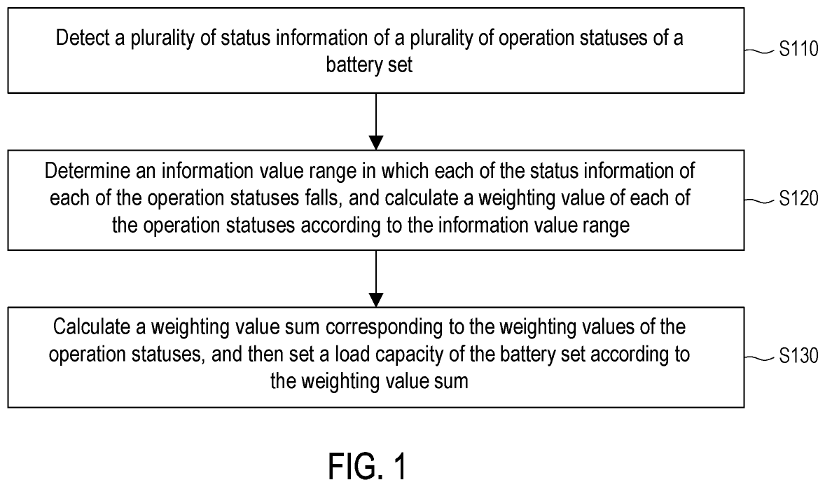

Please refer to FIG. 1. FIG. 1 is a flow chart of a power management method according to an embodiment of the disclosure. First, in step S110, a detection operation is performed on a plurality of status information of a plurality of operation statuses of a battery set. Then, in step S120, for each of the status information of each of the operation statuses, an information value range within which each of the status information of each of the operation statuses falls is determined, and then a weighting value of each of the operation statuses is calculated according to the information value range. Next, in step S130, a weighting value sum of all of the weighting values of all of the operation statuses is calculated, and then a load capacity of the battery set is set according to the weighting value sum. Each step of the embodiment will be described in more detail below.

In step S110, a measurement operation may be performed on the plurality of operation statuses of the battery set in real time. In the embodiment, the plurality of operation statuses of the battery set include a voltage of the battery set, a temperature of the battery set, and an output current of the battery set. The corresponding status information thereof is a voltage value of the battery set, a temperature value of the battery set, and a current value of the output current of the battery set. In addition, a plurality of reference ranges of each of the operation statuses may be preset, and a plurality of reference weighting values respectively corresponding to the plurality of reference ranges may be set. In step S120, it may be determined which one of the plurality of reference ranges the status information corresponding to each of the operation statuses falls within (hereinafter referred to as the selected reference range). In this way, the reference weighting value corresponding to the selected reference range may be set as the weighting value of each of the operation statuses.

According to the above description, it may be known that through step S120, a plurality of weighting values corresponding to the plurality of operation statuses of the battery set may be obtained. Next, in step S130, by performing an addition operation on the plurality of weighting values, the weighting value sum may be calculated. Furthermore, through step S130, it may be determined which one of a plurality of weighting value ranges the weighting value sum falls within, and the setting operation on the load capacity of the battery set is performed according to the weighting value range within which the weighting value sum falls. Here, the weighting value range may be preset.

It is worth noting that the detection operation on the plurality of status information of the plurality of operation statuses of the battery set in step S110 may be performed dynamically and in real time. Therefore, the load capacity of the battery set may also be adjusted in real time and dynamically according to the operation statuses of the battery set, which may improve the power supply efficiency of the battery set.

The power management method of the embodiment reviews the status information of the plurality of operation statuses of the battery set and calculates the weighting value sum of the plurality of operation statuses to serve as a basis for adjusting the load capacity of the battery set.

In this way, the power management method of the embodiment adjusts the load capacity by integrating the plurality of operation statuses of the battery set, instead of adjusting the load capacity through a single fixed setting method, so as to effectively improve the power supply efficiency of the battery set.

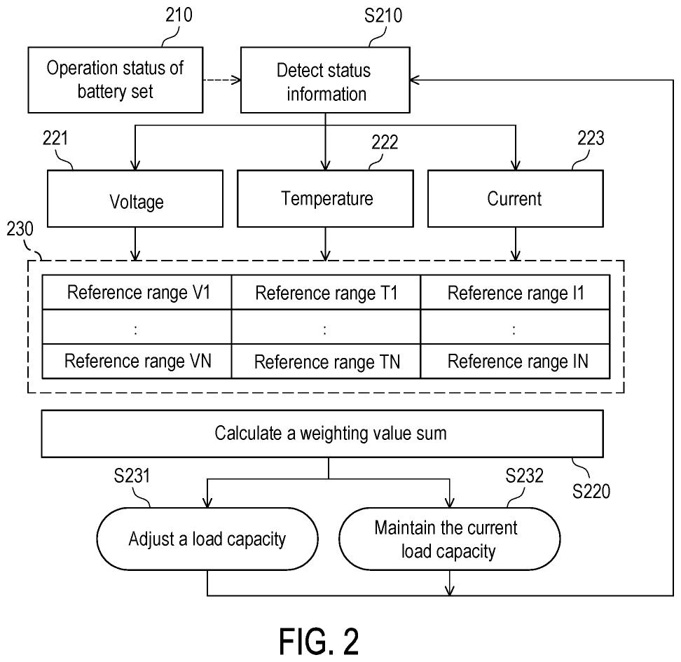

Please refer to FIG. 2. FIG. 2 is a flow chart of a power management method according to another embodiment of the disclosure. First, in step S210, a detection operation on status information of an operation status 210 of a battery set is performed. The operation status 210 of the battery set includes a voltage 221 of the battery set, a temperature 222 of the battery set, and a current 223 of the battery set. On the other hand, a reference range information 230 may be established in advance. The reference range information 230 includes a plurality of reference ranges V1 to VN corresponding to the voltage 221; a plurality of reference ranges T1 to TN corresponding to temperature 222; and a plurality of reference ranges I1 to IN corresponding to the current 223.

It is worth mentioning that in the reference range information 230, a plurality of reference weighting values may be respectively set corresponding to the plurality of reference ranges V1 to VN, the plurality of reference ranges T1 to TN, and the plurality of reference ranges I1 to IN.

In an embodiment of the disclosure, the reference range information 230 may be implemented in the form of a lookup table. By using the detected status information of the operation status 210 to perform a lookup operation on the reference range information 230, a selected reference range within which each of the status information falls may be obtained, and a weighting value corresponding to each of the operation statuses may be obtained accordingly.

Next, in step S220, a weighting value sum of a plurality of weighting values of a plurality of operation statuses may be calculated. In step S231, a load capacity of the battery set is adjusted according to the weighting value sum, or in step S232, the current load capacity of the battery set is maintained according to the weighting value sum.

It is worth mentioning that steps S210 to S231 and S232 of the embodiment may form a loop and continue in real time and dynamically, so as to monitor the operation status 210 of the battery set in real time and dynamically, and effectively maintain the power supply efficiency of the battery set.

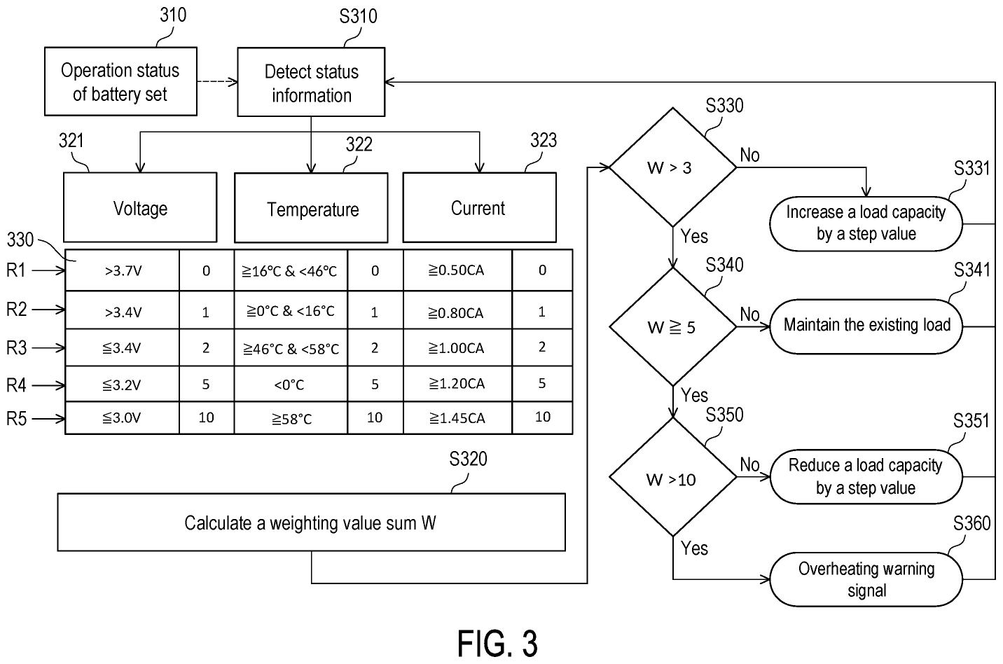

Please refer to FIG. 3. FIG. 3 is a flow chart of a power management method according to another embodiment of the disclosure. In step S310, a detection operation on status information of an operation status 310 of a battery set is performed. Same as the previous embodiment, the operation status 310 of the battery set includes a voltage 321 of the battery set, a temperature 322 of the battery set, and a current 323 of the battery set. On the other hand, a reference range information 330 may be established in advance. In the embodiment, in the reference range information 330, there are reference ranges corresponding to the voltage 321 and respectively disposed in a first row R1 to a fifth row R5, which are >3.7V, >3.4V, ≤3.4V, ≤3.2V, and ≤3.0V. The reference ranges respectively correspond to weighting values 0, 1, 2, 5, and 10. In the reference range information 330, there are further reference ranges corresponding to the temperature 322 and respectively disposed in the first row R1 to the fifth row R5, which are >16° C. & <46° C., ≥0° C. & <16° C., ≥46° C. & <58° C., <0° C., and ≥58° C. The reference ranges respectively correspond to weighting values 0, 1, 2, 5, and 10. In the reference range information 330, there are also reference ranges corresponding to the current 323 and respectively disposed in the first row R1 to the fifth row R5, which are ≥0.50 CA, ≥0.80 CA, ≥1.00 CA, ≥1.20 CA, and ≥1.45 CA. The reference ranges respectively correspond to weighting values 0, 1, 2, 5, and 10. CA is a discharge rate value of the battery set per unit ampere.

It is worth mentioning that when performing a lookup operation on the status information of the operation status 310, it is necessary to look up sequentially from the first row R1 to the fifth row R5. Take the lookup operation on the status information of the voltage 321 as an example. If the status information of the voltage 321 is 3.3V, the lookup operation may be performed first according to the reference range (>3.7V) of the corresponding first row R1, and a lookup result “no” may be obtained. Then the lookup operation on the reference range (>3.4V) of the corresponding second row R2 may be performed. At this time, a determination operation is performed to determine whether the status information of the voltage 321 is greater than 3.4V and less than or equal to 3.7V. A lookup result “no” may also be obtained. Then, a lookup operation on the reference range (<3.4V) of the corresponding third row R3 may be performed. A lookup result “yes” may be obtained, and according to this, the operation status 310 may be set in which the weighting value corresponding to the voltage 321 is 2.

Here, the lookup operation on the reference range needs to continue, and the lookup operation on the reference range (≤3.2V) of the corresponding fourth row R4 needs to be performed, and a lookup result “no” is obtained. In this way, the operation status 310 is maintained in which the weighting value corresponding to the voltage 321 is 2.

The lookup method of the status information of the operation status 310 being the temperature 322 and the current 323 is similar to the above description and will not be repeated here.

Continuing the above embodiment, in step S320, a weighting value sum W corresponding to a plurality of weighting values of a plurality of operation statuses 310 may be calculated, and in step S330, it is determined whether the weighting value sum W is greater than a preset value. 3. If the weighting value sum W is not greater than the preset value 3, step S331 may be performed to increase a load capacity by a step value; if the weighting value sum W is greater than the preset value 3, step S340 may be executed. In step S340, it is determined whether the weighting value sum W is greater than or equal to another preset value 5. If the weighting value sum W is less than the preset value 5, step S341 may be executed so that the existing load is maintained unchanged; if the weighting value sum W is greater than or equal to the preset value 5, step S350 may be executed. In step S350, it is determined whether the weighting value sum W is greater than another preset value 10. If the weighting value sum W is not greater than the preset value 10, step S351 may be executed to reduce the load capacity by a step value; if the weighting value sum W is greater than the preset value 10, step S360 may be executed to send an overheating warning signal.

The preset values 3, 5, and 10 are configured to define a plurality of weighting value ranges. Through the comparison operations in steps S330, S340, and S350, it may be determined which weighting value range the weighting value sum W falls within, and an adjustment operation on the load capacity (that is, the output power) of the battery set may be performed according to the weighting value range within which the weighting value sum W falls.

Certainly, the preset values may be set by the designer according to the actual operation status 310 of the battery set, which is not limited thereto. In addition, the number of the preset values is also not limited thereto. The designer may set the number of the preset values according to the quantity requirements of the weighting value range.

It is worth mentioning that in the embodiment of the disclosure, the numerical value of the reference range may be set by the designer according to the actual status of the battery set. The numerical value of FIG. 3 is merely an example for description and is not intended to limit the scope of the disclosure. In other embodiments of the disclosure, the number of the reference ranges corresponding to different operation statuses may be the same or different.

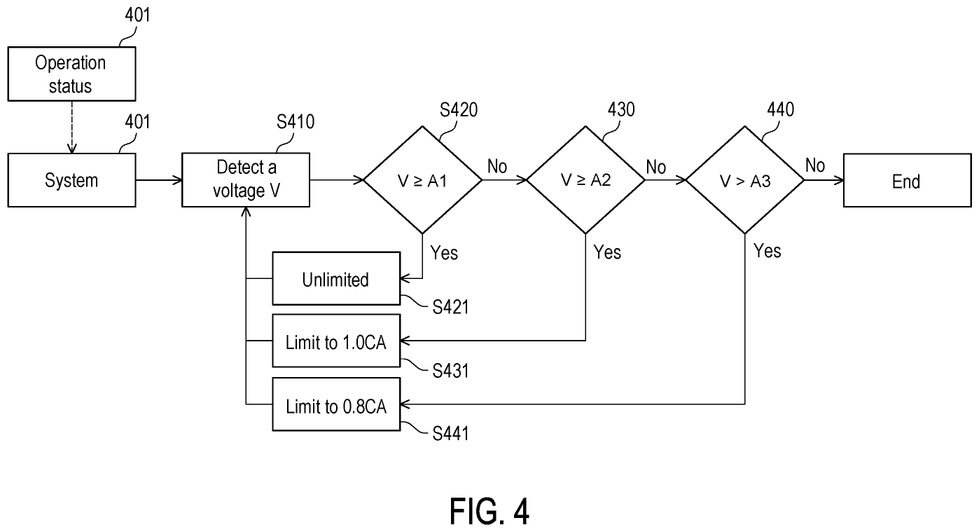

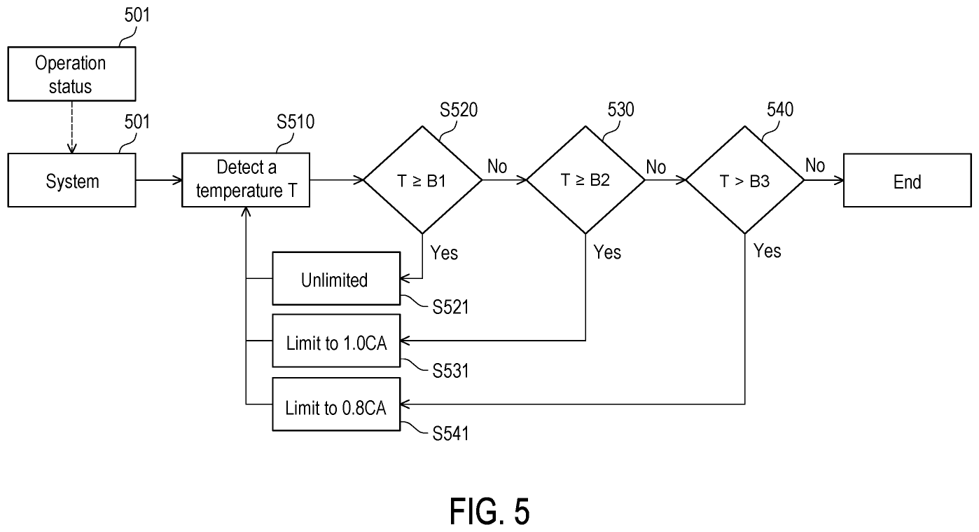

Please refer to FIG. 4 and FIG. 5 below. FIG. 4 and FIG. 5 are schematic diagrams of a setting method of a reference range in a power management method according to the embodiment of the disclosure. Engineers may conduct tests according to each of the operation statuses of the battery set, and set the reference range in the power management method of the embodiment of the disclosure according to the test results. FIG. 4 is a voltage of a battery set being tested. A system 402 may test an operation status 401 of the voltage of the battery set, detect a voltage V of the battery set in step S410, and respectively compare the detected voltage V with preset values A1, A2, and A3 in steps S420, S430, and S440. The preset value A1 may be greater than the preset value A2, and the preset value A2 may be greater than the preset value A3. In the embodiment, the system 402 may be any electronic device.

When it is determined in step S420 that the voltage V is greater than or equal to the preset value A1, the load capacity of the battery may be set to an unlimited status (step S421), and when it is determined in step S420 that the voltage V is less than the preset value A1, step S430 is executed. When it is determined in step S430 that the voltage V is greater than or equal to the preset value A2, the load capacity of the battery may be set to 1.0 CA (step S431), and when it is determined in step S430 that the voltage V is less than the preset value A2, step S440 is executed. When it is determined in step S440 that the voltage V is greater than the preset value A3, the load capacity of the battery may be set to a relatively low 0.8 CA (step S441), and when it is determined in step S440 that the voltage V is not less than the preset value A3, this test process ends.

By reviewing the operation stability of the battery set through the above test process, the appropriate implementation values of the preset values A1 to A3 may be found. According to the preset values A1 to A3, a plurality of reference ranges corresponding to where the operation status is a voltage may be set accordingly in the power management method of the disclosure.

In FIG. 5, a temperature of a battery set being tested is used as an example. A system 502 may test an operation status 501 of the voltage of the battery set, detect a temperature T of the battery set in step S510, and respectively compare the detected temperature T with preset values B1, B2, and B3 in steps S520, S530, and S540. The preset value B1 may be greater than the preset value B2, and the preset value B2 may be greater than the preset value B3.

When it is determined in step S520 that the temperature T is greater than or equal to the preset value B1, the load capacity of the battery may be set to an unlimited status (step S521), and when it is determined in step S520 that the temperature T is less than the preset value B1, step S430 is executed. When it is determined in step S530 that the temperature T is greater than or equal to the preset value B2, the load capacity of the battery may be set to 1.0 CA (step S531), and when it is determined in step S530 that the temperature T is less than the preset value B2, step S540 is executed. When it is determined in step S540 that the temperature T is greater than the preset value B3, the load capacity of the battery may be set to a relatively low 0.8 CA (step S541), and when it is determined in step S540 that the temperature T is not less than the preset value B3, this test process ends.

By reviewing the operation stability of the battery set through the above test process, the appropriate implementation values of the preset values B1 to B3 may be found. According to the preset values B1 to B3, a plurality of reference ranges corresponding to the operation status being a temperature may be set accordingly in the power management method of the disclosure.

Regarding the embodiment of the power management method of the disclosure, the plurality of reference ranges corresponding to the operation status being a current may be tested according to similar processes of FIG. 4 and FIG. 5, and obtained according to the test results. The relevant details will not be repeated here.

It is worth noting that in the test processes shown in FIG. 4 and FIG. 5, corresponding to one of the operation statuses, the number of the preset values A1 to A3 or B1 to B3 does not need to be limited to 3. Engineers may set the reference range corresponding to each of the operation statuses by setting the number of the preset values by themselves so as to carry out the test processes shown in FIG. 4 and FIG. 5.

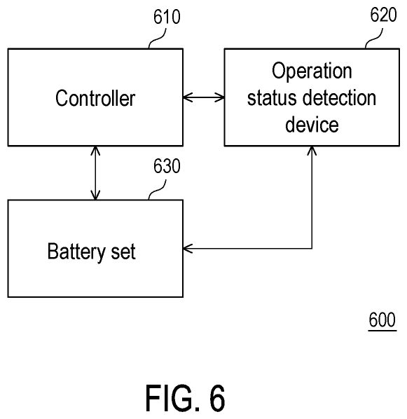

Please refer to FIG. 6. FIG. 6 is a schematic diagram of an electronic device according to an embodiment of the disclosure. An electronic device 600 includes a controller 610, an operation status detection device 620, and a battery set 630. The controller 610 is coupled to the operation status detection device 620 and the battery set 630. The operation status detection device 620 is also coupled to the battery set 630. The operation status detection device 620 is configured to detect a plurality of operation statuses of the battery set 630, such as voltage, current, and temperature. The operation status detection device 620 may have a plurality of detection circuits, such as a voltage detection circuit, a current detection circuit, and a temperature detection circuit, respectively configured to detect the voltage, the current, and the temperature of the battery set 630. The circuit architectures of the voltage detection circuit, the current detection circuit, and the temperature detection circuit may be implemented respectively using circuit architectures of a voltage detector, a current detector, and a temperature detector that are well known to those skilled in the art, which is not limited thereto.

The controller 610 receives a plurality of operation information of the operation status of the battery set 630 detected by the operation status detection device 620, and executes a plurality of steps of the power management method of the foregoing embodiments according to the status information. Regarding the implementation details of the plurality of steps of the power management method, please refer to the description in the foregoing embodiments, which will not be repeated here.

In the embodiment, the controller 610 may be a processor with computing capabilities. Alternatively, the controller 610 may be designed using hardware description language (HDL) or any other digital circuit design method well known to those skilled in the art, and may be a hardware circuit implemented through a field programmable gate array (FPGA), a complex programmable logic device (CPLD), or an application-specific integrated circuit (ASIC).

To sum up, the disclosure detects the status information of the plurality of operation statuses of the battery set dynamically and in real time, calculates the weighting values of the operation statuses according to the status information, and then uses the weighting value sum as the basis for setting the load capacity of the battery set. In this way, the power management operation may avoid adjusting the load capacity of the battery set through a single and fixed setting method, which may effectively improve the power supply efficiency of the battery set.

What is claimed is:

1. A power management method, comprising:
detecting a plurality of status information of a plurality of operation statuses of a battery set;
determining an information value range within which each of the status information of each of the operation statuses falls, and calculating a weighting value of each of the operation statuses according to the information value range; and
calculating a weighting value sum corresponding to the weighting values of the operation statuses to set a load capacity of the battery set according to the weighting value sum.

2. The power management method according to claim 1, wherein the step of calculating the weighting value of each of the operation statuses according to the information value range within which each of the status information of each of the operation statuses falls comprises:
setting a plurality of reference ranges for each of the operation statuses;
setting a plurality of reference weighting values respectively corresponding to the reference ranges; and
determining a selected reference range of one of the reference ranges within which each of the status information falls, and setting the reference weighting value corresponding to the selected reference range to be the weighting value of each of the operation statuses.

3. The power management method according to claim 1, wherein the step of calculating the weighting value sum corresponding to the weighting values of the operation statuses to set the load capacity of the battery set according to the weighting value sum comprises:
setting a plurality of weighting value ranges; and
setting the load capacity of the battery set according to one of the weighting value ranges within which the weighting value sum falls.

4. The power management method according to claim 3, wherein the weighting value ranges comprise a first weighting value range, a second weighting value range, and a third weighting value range, a value of the first weighting value range is lower than a value of the second weighting value range, the value of the second weighting value range is lower than a value of the third weighting value range, and the step of setting the load capacity of the battery set according to one of the weighting value ranges within which the weighting value sum falls comprises:
increasing the load capacity of the battery set by a first step value when the weighting value sum falls within the first weighting value range;
maintaining the load capacity of the battery set unchanged when the weighting value sum falls within the second weighting value range; and
reducing the load capacity of the battery set by a second step value when the weighting value sum falls within the third weighting value range.

5. The power management method according to claim 4, further comprising:
sending an overheating warning signal when the weighting value sum exceeds the third weighting value range.

6. The power management method according to claim 4, wherein the first step value is equal to or not equal to the second step value.

7. The power management method according to claim 1, wherein the operation statuses comprise a temperature of the battery set, a voltage of the battery set, and an output current of the battery set.

8. An electronic device, comprising:
a battery set;
an operation status detection device, coupled to the battery set, and configured to detect a plurality of status information of a plurality of operation statuses of the battery set; and
a controller, coupled to the operation status detection device, and configured to:
determine an information value range within which each of the status information of each of the operation statuses falls, and calculate a weighting value of each of the operation statuses according to the information value range; and
calculate a weighting value sum corresponding to the weighting values of the operation statuses to set a load capacity of the battery set according to the weighting value sum.

9. The electronic device according to claim 8, wherein the controller is further configured to:
set a plurality of reference ranges for each of the operation statuses;
set a plurality of reference weighting values respectively corresponding to the reference ranges; and
determine a selected reference range of one of the reference ranges within which each of the status information falls, and set the reference weighting value corresponding to the selected reference range to be the weighting value of each of the operation statuses.

10. The electronic device according to claim 8, wherein the controller is further configured to:
set a plurality of weighting value ranges; and
set the load capacity of the battery set according to one of the weighting value ranges within which the weighting value sum falls.

11. The electronic device according to claim 10, wherein the weighting value ranges comprise a first weighting value range, a second weighting value range, and a third weighting value range, a value of the first weighting value range is lower than a value of the second weighting value range, the value of the second weighting value range is lower than a value of the third weighting value range, and the controller is further configured to:
increase the load capacity of the battery set by a first step value when the weighting value sum falls within the first weighting value range;
maintain the load capacity of the battery set unchanged when the weighting value sum falls within the second weighting value range; and
reduce the load capacity of the battery set by a second step value when the weighting value sum falls within the third weighting value range.

12. The electronic device according to claim 11, wherein the controller is further configured to:
send an overheating warning signal when the weighting value sum exceeds the third weighting value range.

13. The electronic device according to claim 11, wherein the first step value is equal to or not equal to the second step value.

14. The electronic device according to claim 11, wherein the operation statuses comprise a temperature of the battery set, a voltage of the battery set, and an output current of the battery set.
